(19) United States
(12) Patent Application Publication
(10) Pub. No.: US 2005/0199698 A1
(43) Pub. Date: Sep. 15, 2005

(54) Product identifier reading, product use instructions speaking system

(75) Inventor: Kenneth P. Glynn, Flemington, NJ (US)

Correspondence Address: Kenneth P. Glynn;Glynn & Associates, P.C., 24 Mine Street, Flemington, NJ, 08822, US

(73) Assignee: iVoice, Inc.

(21) Appl. No.: 10/940,868

(22) Filed: Sep. 14, 2004

Related U.S. Application Data
(63) Continuation-in-part of application No. 10/801,391, filed on Mar. 15, 2004.

(51) Int. Cl. G06F 17/00

(52) U.S. Cl. 235/375; 340/572.1; 340/692; 707/104.1

(57) ABSTRACT

A method of communicating product use instructions to a user for a product having a readable identifier includes (a) providing a plurality of product containers, each with a product identifier; (b) providing a user read and speak unit having hardware and software to read a product identifier, communicate the product identification via a communication link to a server, receive product use instructions from the server, convert the product use instructions to speech, and speak the product use instructions; (c) providing a server having hardware and software to cooperate with the unit and accomplish the foregoing. The system using this combination of one or more units, a server and a communications link, may use telephones, computers or stand-alones for the units.

### REFERENCE TO RELATED CASES

This patent application is a continuation-in-part of United States copending application Ser. No. 10/801,391 filed on Mar. 15, 2004, by an inventor herein, with common assignment of ownership, and entitled “Wirelessly Loaded OTC Speaking Medicine Container”, which is a continuation-in-part of copending application Ser. No. ______(not yet available, Docket No. IVC-114A) filed on Jan. 30, 2004, entitled “Wirelessly Loaded Speaking Medicine Container”, by an inventor herein, with common assignment of ownership.

### BACKGROUND OF THE INVENTION

1. Field of the Invention

The present invention relates to systems and methods for obtaining product use instructions separate and apart from reading product containers or printed product inserts. The present invention utilizes product identification devices, such as bar codes and RF chips, located on a product container, and, more particularly, also utilizes a read and speak unit for reading the product identification device and communicating with a server containing the product user instructions. The server sends the product user instructions to the unit and the unit speaks the instructions to the user. Thus, the present invention relates to both the method of performing these steps, and the combination of devices and software (the system) for doing this.

2. Information Disclosure Statement

The following prior art is prior art of interest:

U.S. Pat. No. 6,563,911 B2 describes the present invention a speech enabled automatic telephone dialer device, system, and method using a spoken name corresponding to name-telephone number data of computer-based address book programs. The invention includes user telephones connected to a PBX-type telephony mechanism, which is connected to a telephony board of a name dialer device. User computer workstations containing loaded address book programs with name-telephone number data are connected to the name dialer device. The name dialer device includes a host computer in a network; a telephony board for controlling the PBX for dialing; a memory within the host computer for storing software and name-telephone number data; and, software to access computer-based address book programs, to receive voice inputs from the PBX-type telephony mechanism, to create converted phonemes from names to match voice inputs with specific name-telephone number data from the computer-based address book programs for initiating an automatic dialing.

U.S. Pat. No. 6,463,462 B1 describes an automated system for delivery of messages to multiple recipients, and for processing of responses to the messages, includes a message client, message server, and system database. A message is created using universal message form. The message content can be translated in to multiple formats and sent to one or more different recipients using one or more different types of messaging devices, including pagers, telephones, fax machines, and e-mail readers. A recipient profile manager allows each recipient to select the messaging devices to be used for message delivery as well as preferred messaging schedules, priorities, and messages security. Receipt of the messages by the recipients is verified, response requirements collected and consolidated from multiple sources and presented to the message originator in structured format.

U.S. Pat. No. 6,394,278 B1 describes a system and method for assisting an operator in sorting mail includes a wireless headset equipped with a microphone, and a workstation that includes a processing unit, voice-recognition and voice-synthesis circuitry, and a database. In operation, addressee information spoken into the microphone is transmitted to the work station where it is used to search the database. Destination information from a matching database record is then output to the operator on one or more of a display terminal, head set speakers, and heads-up display fixed to the head-set. The convenience and enhanced capability provided by this system steaminess operator productivity and sorting volume. The embodiments disclosed herein are primarily directed to a headset that is operated completely remotely from the processing unit, and also to a head set comprising a heads up display having means by which an operator can access the database.

U.S. Pat. No. 6,380,858 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various information about medicament contained within a respective container. A Smart Tray is equipped with a processor and reader that interrogates each respective electromagnetic tag to identify medicament(s) contained within each container. Using the retrieved information, a Smart Tray provided visual and/or audio signals to a patient to remind the patient when and how much of various medicaments to take. A Smart Tray also monitors, via the reader, when a mediation container is removed. A Smart Tray can communicate with one or more third parties, such as healthcare products and services via a computer network. In addition, a Smart Tray can communicate with various appliances and can modify medication regimens for particular medicaments in response to data received from various appliances.

U.S. Pat. No. 6,294,999 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various information about medicament contained within respective container. A Smart Tray is equipped with a processor and reader that interrogates each respective electromagnetic tag to identify medicament(s) contained within each container. Using the retrieved information, a Smart Tray provides visual and/or audio signals to a patient to remind the patient when and how many of various medicaments to take. A Smart Tray also monitors, via the reader, when a medication container is removed. A Smart Tray can communicate with one of more third parties, such as healthcare providers, pharmacies, and other suppliers of healthcare products and services via a computer network. In addition, a Smart Tray can communicate with various appliances and can modify medication regimens for particular medicaments in response to data received from various appliances.

U.S. Pat. No. 6,150,942 describes an interactive prescription compliance, and life safety system that provides remote and on site verification of procedures related to the health status of a person, including taking of medicines, responsiveness to queries, and attendance of health care and service providers in the home by providing for signals to and from a person's location, with alarm activation when a deviation from a preprogrammed procedure occurs.

U.S. Pat. No. 6,032,155 describes an invention that relates to a method and apparatus for administering prescribed medication to a patient. The prescribed medication administration system and apparatus dispense prescribed medication, verify the medication is given to a correct patient by and authorized healthcare worker and tracks and records the administration of the medication. The system utilizes a workstation connected to a database containing prescribed medication dose information for various patients. A healthcare worker uses the workstation to manually or automatically dispenses the medication the portable container. An information device is secured to the portable container during transport and administration of the medication to the intended patient. The information device prevents access to the medication or warns the healthcare worker of a potential error if the medication is delivered to the wrong patient or administered by an unauthorized healthcare worker. The information device records actual consumption information, and delivers this information back the workstation database or to a hospital or pharmacy database.

U.S. Pat. No. 6,021,433 describes a system and method for data communication connection on-line networks with on-line computers. The present system provides for broadcast of up to the minute notification centric data there by providing an instant call to action for users who are provided with the ability to instantaneously retrieve further detailed information. Information sources transmit data to a central broadcast server, which preprocesses the data for wireless broadcast. The notification centric portions of data are wirelessly broadcast to wireless receiving devices that are attached to computing devices. Upon receipt of the dada the computing device, the user is notified through different multimedia alerts that there is an incoming message. Wirelessly broadcasted URL's, associated with the data, are embedded in data packets and provide an automated wired or wireless connection back to the information source for obtaining detailed data.

U.S. Pat. No. 6,018,289 describes a prescription compliance device which aids patients in complying with instructions given by a physician for taking prescription medication. The device reminds a patient when the next dose of medication is to be taken and indicates whether a specified dose has been taken. The device includes a microcontroller, a display, a program memory for storing pre-programmed medication-taking regimens and for programming the device as to the time and day on which the first dose of medication is to be taken, a display which alternately displays the current time and a time at which a next dose of medication is to be taken, and an alarm which alerts the patient at times when a dose of medication is to be taken. The selector includes an event switch, which is activated by the patient after taking a dose of medication so as to record the taking of the medication and to cause the microcontroller to effect the display of the next time at which a dose of medication is to be taken. A memory may also be included to record the times at which a patient takes doses of medication. The device is small enough to be attached to medication containers, and includes a remote programming feature via a wireless link.

U.S. Pat. No. 5,917,429 describes a means which digital data are communicated between a portable data-gathering unit and a date-receiving unit without direct electrical connection by transmitting the data over a contactless connection system. In a preferred embodiment, data flow is bidirectional.

U.S. Pat. No. 5,846,089 describes a medicine container that provides audible dosage instructions in a voice recognizable to the user, so that the user, even with a sight or like disability, can rely on voice recognition as providing verification of the accuracy and particular appropriateness of the dosage instructions to the user of the medicine container.

U.S. Pat. No. 5,835,455 describes a reprogrammable device for removably receiving a medicine container and for providing audio instructions to a patient for taking a medication. When a medicine container is removed from the device by the patient so that the patient may take the medicine, the device can be activated to play a pre-recorded individualized message from the pharmacist providing the patient audio instructions for taking the medication.

U.S. Pat. No. 5,774,865 describes the patient compliance and monitoring device that utilizes a tray with a base for holding medicine containers such as bottles. Inside the base attached to the tray in a weight scale connected to a computer. Also connected to the computer are an alphanumeric keyboard and an LCD monitor which attached to the base. The computer entails a microprocessor connected to ROM and RAM and encoded with instruction sets to determine the dosage taken by a user as well as the date and time taken. The medicine containers are detected, preferably, by a bar code reader inside the base scanning bar code labels attached to the bottom of the medicine containers.

U.S. Pat. No. 5,014,798 describes a present invention that is directed to a cap for a medicine bottle for monitoring a patient's medicine compliance. In involves weighing a container of medicine with cap with includes scale means located therein which is connected to a computer chip with a display unit also located in or on the cap. The chip may store the starting weight or tare weight, plus total weight and when the container or medicine is picked up by the cap at any time, actual weight is fed to the chip. The computer chip may then determine the difference between the starting weight and/or display actual amount of medicine remaining or consumed. The container of medicine is reweighed from time to time with the cap and then chip may compare actual weight with compliance required weight to determine compliance and the cap may visually display the compliance results on the display unit to inform the patient. An optional audio assist may direct the patient to “call the doctor” if a significant compliance deviation is recognized.

Notwithstanding the prior art, the present invention is neither taught nor rendered obvious thereby.

### SUMMARY OF THE INVENTION

The present invention relates to a system and a method of communicating product use instructions to consumers. These instructions may include assembly instructions, utilization instructions, maintenance instructions or any combination of these or other instructions that a manufacturer or product seller may desire to communicate to the user (referred to herein as “product use” instructions), and may also include product warnings or the like.

The present invention is a product identifier reading, product use instructions speaking system, which includes: (a.) a user read and speak unit having hardware and software to:
(i.) read a product identifier of a product to obtain a product identification;
(ii.) communicate the product identification via a communication link to a server,
(iii.) in response to the communicated product identification, receive product use instructions for the product from the server;
(iv.) convert the product use instructions to speech; and
(v.) speak the product use instructions;
   (b.) a server having hardware and software to:
(i.) receive the product identification from the user read and speak unit;
(ii.) store separate product use instructions for a plurality of different product identifications;
(iii.) match the product identification to a specific stored set of product use instructions;
(iv.) communicate the product use instructions to the user read and speak unit via the communication link; and,
   (c.) a communication link adapted to communicatively connect the user read and speak unit to the server.

In some preferred embodiments, the present invention product identifier reading, product use instructions speaking system has a product identifier located on the product or its packaging that is selected from the group consisting of bar code, alpha-numeric code band and RFID chip. The bar code may be a UPC code or other bar code with or without plural types of information (product i. d., manufacturing date, use by date, run number, for example).

In some preferred embodiments, the product identifier reading, product use instructions speaking system communication link includes a wireless link.

The user read and speak unit may be a stand alone unit, or it may be an element or component of a more complex device. For example, it may be included in a kitchen appliance, or included within a computer selected from the group consisting of desktop, laptop, notebook and PDA. Alternatively, it could be included in a telephone, either a land line phone, or a wireless phone, e.g. a cell phone.

In some preferred embodiments, the user read and speak unit includes a bar code reader. In other embodiments, the user read and speak unit further includes hardware and software to:
(vi.) recognize product identification speech input;
(vii.) covert the speech input to digital data; and
(viii.) communicate the digital data to the server to match the product identification to a specific stored set of product use instructions for subsequent communication from the server to the user read and speak unit.

In some preferred embodiments, the communication link includes an internet connection.

In some preferred embodiments, there are a plurality of user read and speak units and a corresponding plurality of communication links. For example, there may be a plurality of user read and speak units that are located near food preparation areas, and the product use instructions include at least one preparation recipe for each of the plurality of stored product use instructions.

The present invention also relates to a method of communicating product use instructions to a user for a product having a readable identifier. This method includes:
(a.) providing a plurality of product containers, each of the plurality of product containers including a storage area for a product, and including a product identifier,
(b.) providing at lest one user read and speak unit having hardware and software to:
   (i.) read a product identifier of a product to obtain a product identification;
   (ii.) communicate the product identification via a communication link to a server;
   (iii.) in response to the communicated product identification, receive product use instructions for the product from the server;
   (iv.) convert the product use instructions to speech; and
   (v.) speak the product use instructions;
(c.) providing a server having hardware and software to:
   (i.) receive the product identification from the user read and speak unit;
   (ii.) store separate product use instructions for a plurality of different product identifications;
   (iii.) match the product identification to a specific stored set of product use instructions;
   (iv.) communicate the product use instructions to the user read and speak unit via the communication link; inputting the user input means to create product use instruction text;
(d.) providing a communication link adapted to communicatively connect the user read and speak unit to the server. converting the text to electronic speech;
(e.) reading a product identifier of a product of the plurality of products with one of the at least user read and speak unit and communicating through the link to and from the server to cause the user read and speak unit to speak the user instructions.

In many instances, there are a plurality of product containers that are provided with product identification information of the same type and model i.e., the same i. d. number or bar code or chip. The concept of the “product of the same type” may mean identical products or may mean different products that are similar enough that the same instructions would apply to all such products. For example, instructions for assembly of a bed frame would be identical for single bed frames, double bed frames and queen bed frames. Thus, since the only difference would be the length of the cross members, these products would be considered the same product for purposes of this invention because the same assembly instructions would apply. Reading a bar code on the packaging (taken to mean on the product itself or its wrappings, containers, etc.) of any size bed frame would yield the same assembly instructions being spoken back to the user or consumer. Likewise, a plurality of different paintings in frames would have different renditions and perhaps even different size frames, but the same instructions would apply to all of these for hanging the frames. Also, the same instructional and safety information could be used for a package or container having two molly screws or for one having twenty five molly screws; likewise, for a four ounce container of wrinkle-removing facial cream and a twenty ounce container of the same product.

In the present invention method, the product itself may be added to the container before and/or during and/or after the transmittal of the wave file to the receiving chip of the container. As suggested above, while the present invention refers to the product identifier on the packaging or container, the same information may be located on the product itself without exceeding the intended scope of the present invention.

### BRIEF DESCRIPTION OF THE DRAWINGS

The present invention should be more fully understood when the specification herein is taken in conjunction with the drawings appended hereto wherein:

FIG. 1 illustrates a schematic diagram of one preferred embodiment of the present invention method and system; and,

FIG. 2 shows a diagrammatic representation of a present invention system.

### DETAILED DESCRIPTION OF THE PRESENT INVENTION

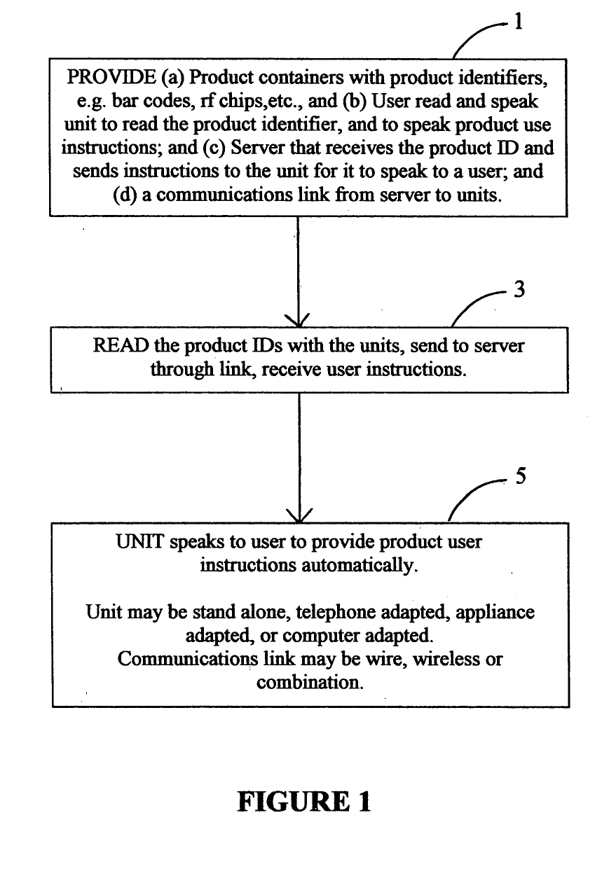

FIG. 1 illustrates a schematic diagram of one preferred embodiment of the present invention method and system. In FIG. 1, the first step in the present invention method, it is necessary to provide a system and subsequently to use that system. Block 1 of FIG. 1 indicates providing product containers with product identifiers, providing a user read and speak unit, providing a server and providing a communications link, specifically as described in Block 1.

The next step in the method is illustration in Block 3 of FIG. 1. Here, users read the product i.d.s with the read and speak units. The read and speak units send product identification information to the central server, which searches its directory to match the product identification information to the correct user instructions and sends the user instruction back to the units.

In Block 5, the units speak to the users to automatically provide product user instructions. Each unit speaks to user to provide product user instructions automatically. Each unit may be stand alone, telephone adapted, appliance adapted, or computer adapted. Communications link may be wire, wireless or combination.

In some embodiments, the server itself will convert user information that is to be sent back into a format that will be transmitted to the units such that the units speak back to the users. (The ability to provide information from storage into speakable format is now a well known capability of one of ordinary skill in the art.) Alternatively, the text to speech capability could be stored in a computer or other location that is interconnected with the units and the server. However, in preferred embodiments, the text to speech conversion occurs at the server and this information is transmitted like any telephone speech, for example, and converted to audible presentation at the read and speak units.

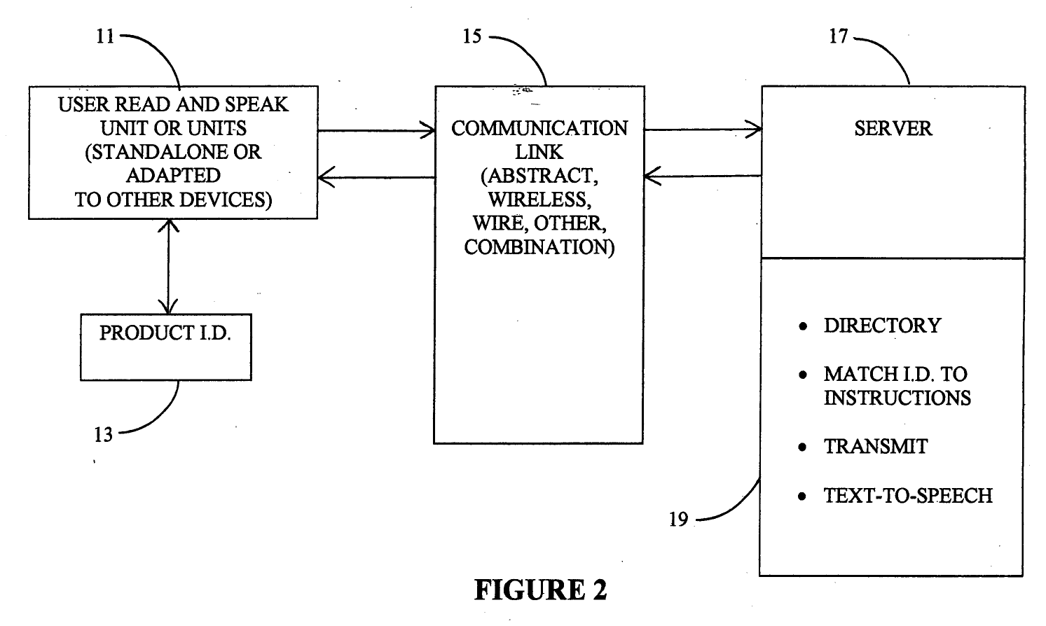

FIG. 2 illustrates a diagrammatic representation of a present invention system. Block 11 shows one or more user read and speak units for reading a product identifier on product 13. These units communicate with communications link 15 to server 17. Server 17 includes sufficient hardware and programming to store and retrieve product use identifier and corresponding product use instructions, receive and transmit capabilities, match incoming identification information to the directory and effectuate text-to-speech.

Central processor 1 requires user input means and this could be any available user means, but is typically a ball, a mouse, a key pad, a microphone, or combinations of these. It also includes text-to-speech means and these are well known systems that convert electronic text to speech. These are well known programs and would be familiar to one of ordinary skill in this art. For example, U.S. Pat. No. 6,394,278 B1 and patents cited therein show speech-to-text and text-to-speech capabilities.

Central processor 1 also includes wave file means to create wave files from the text-to-speech means, as well as wireless transmission means. Wave files creation and wireless transmission, not in the present invention system, are known to the artisan and are described in the cited prior above.

The user will use the input means to create the wave files by normal input of product use instructions, and these are wirelessly transmitted 3 to a plurality of product containers 5. These may be done in batches, sequentially, simultaneously, or in group/step functions. Typically, these are hundreds or thousands or millions of containers with the same product that would utilize the same product instructions.

Each product container 5 includes a microprocessor attached to it that receives the wave file wireless transmission, storage means for storing the wave file and whatever additional software that may be required to create audible speech patterns. Each of the plurality of product containers 5 also include playback and playback start means as well as a power supply. Typically, the microprocessors would be located on the bottom of the product containers and would be cylindrical or otherwise conformed to the general shape of the product container. Alternatively, it could have any convenient shape and be located on any area of the product container or its cover. It would include a start mechanism that could be a button or switch, or its equivalent. A user would simply activate the start mechanism and the microprocessor would automatically playback the product use instructions.

FIG. 2 shows another schematic diagram of an alternative embodiment of a present invention method and system. In this embodiment, the central processor 7 functions similarity to central processor 1 above but creates wave files directly from inputs and transmits 9 these to a plurality of product containers 11. Product containers 11 function similarity to product containers 5 of FIG. 1, except that an optional second start means is included on the product containers with, for example, dual microprocessor capabilities. This could be a cover-connected second start mechanism that would automatically play the first time the cover is removed, or it could be a second start mechanism for playing product warnings.

FIG. 3 shows a diagrammatic representation of a present invention system. There is a central processor, in this case, computer 21 with monitor 23, as well as impute means which, in this embodiment, are shown to be keyboard 25, mouse 27 and pad 29 and microphone 31. A slider, joystick, or touch ball, or any other input means could be included in addition to or in place of those shown in the figure.

Computer 21 could be a master server, a personal computer, or any other type of computer. Computer 21 is connected to transmitter 33 for short distance transmission of the wave file. While this is shown as a separate device wired to computer 21, it could be built in to a computer unit with appropriate hardware, software and middleware. This wirelessly transmits the wave file package with optional unique identifier information to a plurality of product containers 36, 37, 38, 39, 40, and 41, and, more particularly to their microprocessors. Details are shown with respect to container 41, which includes microprocessor 51 attached to container bottom 49. Container 41 includes a typical product storage area 43, a label 45 and a cover 47. Playback start button 53 enables a user to playback the received and stored wave file packet product use instruction as often as desired.

Microprocessor 51 includes a wave file wireless transmission receiving chip and a power supply, as well as storage means and optional unique identifier retrieval means. This could be a plug in port such as port 55.

FIG. 4 illustrates another preferred embodiment of the present invention system for wirelessly transferring product use instructions from a central processor to a product container for subsequent audio playback by a user. Central processor 101 may be arranged as in FIG. 1 or as in FIG. 2 above, and, includes optional unique identifier capabilities 103. This includes sufficient equipment and software to create a unique identification code for each and every product container to which a wave file is sent. This code could be any combination of numbers and/or letters and/or symbols.

In one preferred embodiment of the present invention, the system is provided to a pharmaceutical manufacturer operator or similar functionary, may input the appropriate product use instruction for creation wave file, for subsequent transmission to the receiving product container microprocessors. A number of variations are possible. For example, the wave file may include a unique identifier along with other information, such as the manufacturers names, the contents of the container, product codes, bar code equivalents, etc.

In one preferred embodiment, the software is set up to create records for the manufacturer, such as batch numbers, processing dates, and even print out labels for the medicine containers and create a wave file, with requiring only a single set of inputs. The unique identifier may include any or all of the previously stated information for each batch of particular product containers.

In another embodiment, the software program of the central processor may contain list of various model products with different instructions so that an operator may click a specific product model, and a specific set of product use instructions will appear. The operator will click to confirm and this may be transmitted to the desired lots of product. A preexisting wave file corresponding to that selection by the operator will thus be automatically brought up and wirelessly transmitted to the product container microprocessors when desired and an operator sends an appropriate directive.

Obviously, numerous modifications and variations of the present invention are possible in light of the above teachings. It is therefore understood that within the scope of the appended claims, the invention may be practiced otherwise than as specifically described herein.

1. A product identifier reading, product use instructions speaking system, which comprises:
(a.) a user read and speak unit having hardware and software to:
(i.) read a product identifier of a product to obtain a product identification;
(ii.) communicate said product identification via a communication link to a server;
(iii.) in response to said communicated product identification, receive product use instructions for said product from said server;
(iv.) convert said product use instructions to speech; and
(v.) speak said product use instructions;
(b.) a server having hardware and software to:
(i.) receive said product identification from said user read and speak unit;
(ii.) store separate product use instructions for a plurality of different product identifications;
(iii.) match said product identification to a specific stored set of product use instructions;
(iv.) communicate said product use instructions to said user read and speak unit via said communication link; and,
(c.) a communication link adapted to communicatively connect said user read and speak unit to said server.

2. The product identifier reading, product use instructions speaking system of claim 1 wherein said product identifier is selected from the group consisting of bar code, alpha-numeric code band and RFID chip.

3. The product identifier reading, product use instructions speaking system of claim 2 wherein said bar code is a UPC code.

4. The product identifier reading, product use instructions speaking system of claim 1 wherein said communication link includes a wireless link.

5. The product identifier reading, product use instructions speaking system of claim 1 wherein said user read and speak unit is a stand alone unit.

6. The product identifier reading, product use instructions speaking system of claim 1 wherein said user read and speak unit is included within a computer selected from the group consisting of desktop, laptop, notebook and PDA.

7. The product identifier reading, product use instructions speaking system of claim 1 wherein said user read and speak unit is included within a telephone.

8. The product identifier reading, product use instructions speaking system of claim 7 wherein said telephone is a cell phone.

9. The product identifier reading, product use instructions speaking system of claim 1 wherein said user read and speak unit includes a bar code reader.

10. The product identifier reading, product use instructions speaking system of claim 1 wherein said user read and speak unit further includes hardware and software to:
(vi.) recognize product identification speech input;
(vii.) covert said speech input to digital data; and
(viii.) communicate said digital data to said server to match said product identification to a specific stored set of product use instructions for subsequent communication from said server to said user read and speak unit.

11. The product identifier reading, product use instructions speaking system of claim 1 wherein said communication link includes an internet connection.

12. The product identifier reading, product use instructions speaking system of claim 1 wherein there are a plurality of user read and speak units and a corresponding plurality of communication links.

13. The product identifier reading, product use instructions speaking system of claim 1 wherein there are a plurality of user read and speak units that are located near food preparation areas, and said product use instructions include at least one preparation recipe for each of said plurality of stored product use instructions.

14. A method of communicating product use instructions to a user for a product having a readable identifier, which comprises:
(a.) providing a plurality of product containers, each of said plurality of product containers including a storage area for a product, and including a product identifier;
(b.) providing at lest one user read and speak unit having hardware and software to:
(i.) read a product identifier of a product to obtain a product identification;
(ii.) communicate said product identification via a communication link to a server;
(iii.) in response to said communicated product identification, receive product use instructions for said product from said server;
(iv.) convert said product use instructions to speech; and
(v.) speak said product use instructions;
(c.) providing a server having hardware and software to:
(i.) receive said product identification from said user read and speak unit;
(ii.) store separate product use instructions for a plurality of different product identifications;
(iii.) match said product identification to a specific stored set of product use instructions;
(iv.) communicate said product use instructions to said user read and speak unit via said communication link; inputting said user input means to create product use instruction text;
(d.) providing a communication link adapted to communicatively connect said user read and speak unit to said server;
(e.) reading a product identifier of a product of said plurality of products with one of said at least user read and speak unit and communicating through said link to and from said server to cause said user read and speak unit to speak said user instructions.

15. The method of communicating product use instructions to a user for a product having a readable identifier of claim 14 wherein said product identifier is selected from the group consisting of bar code, alpha-numeric code band and RFID chip.

16. The method of communicating product use instructions to a user for a product having a readable identifier of claim 15 wherein said bar code is a UPC code.

17. The method of communicating product use instructions to a user for a product having a readable identifier of claim 14 wherein said communication link includes a wireless link.

18. The method of communicating product use instructions to a user for a product having a readable identifier of claim 14 wherein said user read and speak unit is a stand alone unit.

19. The method of communicating product use instructions to a user for a product having a readable identifier of claim 14 wherein said user read and speak unit is included within a computer selected from the group consisting of desktop, laptop, notebook and PDA.

20. The method of communicating product use instructions to a user for a product having a readable identifier of claim 14 wherein said user read and speak unit is included within a telephone.

21. The method of communicating product use instructions to a user for a product having a readable identifier of claim 20 wherein said telephone is a cell phone.

22. The method of communicating product use instructions to a user for a product having a readable identifier of claim 14 wherein said user read and speak unit includes a bar code reader.

23. The method of communicating product use instructions to a user for a product having a readable identifier of claim 14 wherein said user read and speak unit further includes hardware and software to:
(vi.) recognize product identification speech input;
(vii.) covert said speech input to digital data; and
(viii.) communicate said digital data to said server to match said product identification to a specific stored set of product use instructions for subsequent communication from said server to said user read and speak unit.

24. The method of communicating product use instructions to a user for a product having a readable identifier of claim 14 wherein said communication link includes an internet connection.

25. The method of communicating product use instructions to a user for a product having a readable identifier of claim 14 wherein there are a plurality of user read and speak units and a corresponding plurality of communication links.

26. The method of communicating product use instructions to a user for a product having a readable identifier of claim 14 wherein there are a plurality of user read and speak units that are located near food preparation areas, and said product use instructions include at least one preparation recipe for each of said plurality of stored product use instructions.
